(19) United States
(12) Patent Application Publication
(10) Pub. No.: US 2014/0341251 A1
(43) Pub. Date: Nov. 20, 2014

(54) SYSTEM AND METHOD FOR DETECTING STRUCTURAL DEFECTS WITHIN A STENT

(71) Applicants: Christoph Diederichs, Stuttgart (DE); Gunther Stockert, Tubingen (DE)

(72) Inventors: Christoph Diederichs, Stuttgart (DE); Gunther Stockert, Tubingen (DE)

(21) Appl. No.: 14/237,344

(22) PCT Filed: Aug. 14, 2012
(86) PCT No.: PCT/EP2012/003465

§ 371 Date: Jul. 21, 2014

(30) Foreign Application Priority Data
Aug. 19, 2011 (EP) 11006835.0

(51) Int. Cl. G01N 25/72; G01J 5/10

(52) U.S. Cl. CPC G01N 25/72; G01J 5/10; G01J 2005/0077
USPC 374/45

(57) ABSTRACT

The invention relates to a system (1) for detecting defects (12) within a structure of struts (2) forming a stent (3), the system comprising a power supply (8) for applying an electrical potential to a proximal end (9) and to a distal end (10) of said stent (3) in order to establish an electrical current flow between said proximal end (9) and said distal end (10), and a temperature sensor (7) such as a infrared camera, adjacent to said stent (3) for detecting a defect (12) within said structure of struts (2), said temperature sensor (7) being adapted to measure a temperature profile of said stent (3). Further, the invention relates to a respective method for detecting those defects (12).

The invention relates to a system and method for detecting defects of struts forming a stent.

### BACKGROUND OF THE INVENTION

In medicine, a natural conduit in a body may be locally flow constricted due to disease. During surgeries, a stent may be inserted into this natural conduit, in order to prevent or counteract such a flow constriction. A stent is an artificial tube-like device having meshed walls, the dimension of the stent, in particular the diameter, being expandable once it is positioned in the natural conduit appropriately, e.g. the local restriction. In the expanded shape, the stent holds the natural conduit open to allow the flow of body fluids or the access for surgery.

In the manufacturing of stents, it has to be ensured that the struts forming the meshed walls of the stent are free of defects, such as broken areas or cracks. Inspecting the stents visually is very difficult because these defects might be hard to detect. In particular, when both opposite ends of a cracked strut are facing each other in a way that there is no visible gap in between both ends, the defect might remain undetected.

### SUMMARY OF THE INVENTION

It is an object of the present invention to provide a system and method for facilitating an inspection of product quality in the manufacturing of stents.

This object is solved with a system and method according to the independent claims. Advantageous further developments are subject of the dependent claims.

According to an embodiment of the invention, a system for detecting defects within a structure of struts forming a stent is provided. The system comprises, a power supply for applying an electrical potential to a proximal end and to a distal end of said stent in order to establish an electrical current flow between said proximal end and said distal end, and a temperature sensor, adjacent to said stent for detecting a defect within said structure of struts, said temperature sensor being adapted to measure a temperature profile of said stent. Due to the application of an electrical potential, defective (fully or partly broken) struts are generating heat in a different extent than intact struts, because of the differing electrical resistance of the defects. This enables to reliably and easily detect defects which are not or hardly visible.

According to another embodiment, said temperature sensor is an infrared camera. This has the advantage that a temperature profile of the entire side facing the infrared camera can be acquired in a single step, resulting in a faster overall inspection.

Advantageously, the system may further comprise a clamping tool for holding the stent. This further facilitates the inspection by providing the stent to be inspected in a known predetermined position.

This clamping tool may advantageously provide at both sides of said clamping tool a connector for said electrical power supply. This provides an easy assembly of the system.

According to a yet further embodiment of the invention, said clamping tool comprises a drive mechanism for rotating said stent. This way, the stent can be inspected easily from all sides.

According to another embodiment of the invention, the system further comprises a loader for automatically loading said stent into said clamping tool adapted for an automatic operation of said system. This allows operating the system in a fully automated manner which is advantageous in mass production.

Advantageously, said temperature sensor is mounted to a mounting fixture adapted to rotate around the stent. This has the same advantages as the rotation of the stent mentioned above.

According to another embodiment of the invention, said struts are made of biocompatible materials ensuring a good medical compatibility.

Advantageously, this biocompatible material is nitinol.

Further, the system may be constructed such that said applied electrical potential is a D.C. voltage.

The above mentioned advantages can also be achieved according to an embodiment of the invention providing a method of detecting defects within a structure of struts forming a stent, said method comprising establishing an electrical current flow between a proximal end and a distal end of said stent by applying an electrical potential to said proximal end and said distal end of said stent; measuring a temperature of the stent with a temperature sensor, and detecting said defect within said structure of struts by locating a spot within said structure of struts dissipating a differing temperature compared to an adjacent area within said structure of struts.

These and other embodiments are described in more detail with reference to the Figures.

### BRIEF DESCRIPTION OF THE FIGURES

FIG. 1 schematically shows a system for detecting defects of struts forming a stent according to an embodiment of the invention, and

FIG. 2 shows the detection of structural defects within the stent by means of the system of FIG. 1.

### DETAILED DESCRIPTION OF THE INVENTION

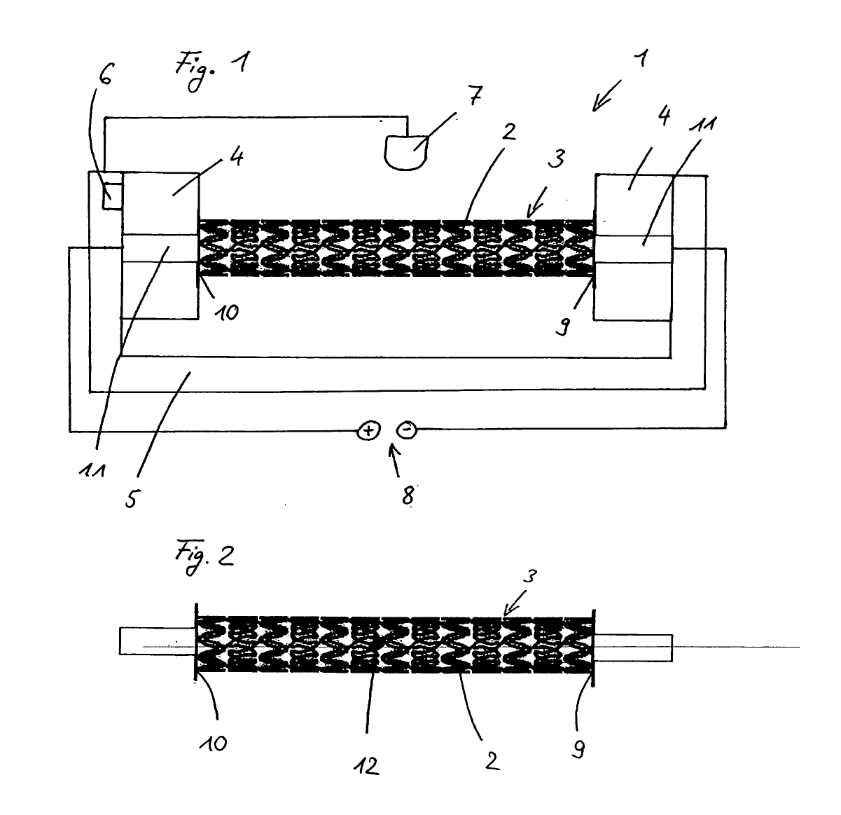

FIG. 1 schematically shows a system 1 for detecting defects of struts 2 forming a stent 3 according to an embodiment of the invention. The system 1 is adapted to hold a stent 3 by means of clamping tools 4. The stent 3 is a tubular expandable medical device, the walls of which are formed by struts 2 forming a metal mesh. The material used for forming the metal mesh is preferably biocompatible material, such as nitinol. The clamping tools 4 are mounted to a mounting fixture 5 in a rotatable manner drivable by a drive mechanism 6 and are adapted to hold the stent 3 in its expanded or unexpanded state. Further, a temperature sensor 7, which is preferably an infrared camera, is attached to the mounting fixture 5. The temperature sensor 7 can be attached in a stationery manner relative to the mounting fixture 5, or can be movable relative thereto. In case it is moveable, a moving device (not shown) can be provided between the temperature sensor 7 and the mounting fixture 5 in form of a rotation device positioned coaxial to the stent and adapted to rotate the temperature sensor 7 around the stent 3 and/or a rail or telescopically moveable holding arm for transversally moving the temperature sensor 7 along a longitudinal direction of the stent 3.

Further, an electric power supply 8 is provided for supplying electrical power, preferably D.C. power, to a proximal end 9 and a distal end 10 of the stent. The power supply 8 is connectable with a connector 11 at each end 9, 10 which establishes the electrical connection to the respective end 9, 10 of the stent 3.

In operation of the system 1, the stent 3 is clamped and held by the clamping tool 4. Then, an electrical current is established between a proximal end 9 and a distal end 10 of the stent 3 by applying an electrical potential by means of the power supply 8. This current flow through the stent 3, or through the struts 2 of the stent 3, generates heat. At cracked struts, the electrical resistance is higher than at non-defective struts leading to more heat at the cracked struts. In case a strut is fully cracked such that the ends do not have contact at all anymore, the current through the remaining struts within the same cross-section of the stent 3 is higher which also causes an increased temperature which is lower than the temperature at the cracked struts the ends of which still contact each other. In order to inspect the stent 3, the temperature profile of the stent 3 is recorded by the temperature sensor 7. In order to do so, the temperature sensor 7 (preferably the infrared camera) and/or the stent 3 are moved relative to each other while the temperature sensor 7 measures the temperature of the stent 3 until the entire surface of the stent 3 is scanned by the temperature sensor 7. Having acquired the temperature profile of the surface of the stent 3, defects 12, i.e. defective struts, can be identified by dissipating a differing temperature compared to an adjacent area within said structure of struts. For example, a higher temperature may indicate a cracked strut, the ends of which are still in contact, whereas a lower temperature at a spot where a strut is supposed to be located may indicate a fully broken strut the ends of which are not contacting each other anymore.

In order to realize a good performance in mass production, a (not shown) loader can be provided for automatically taking the stents 3 to be inspected from a stack, a box or a conveying device, for placing the stent 3 into the clamping tools 4 and for removing the inspected stent 3 from the clamping device after testing. Also, a CPU may be provided for controlling the interaction of the drive mechanism 6, the clamping tool 4, the power supply 8, the temperature sensor 7 and the loader. Depending on the outcome of the testing, namely depending on the stent 3 having defects or not, the CPU may control the loader such that it removes the stent 3 from the clamping tool 4 and places the non-defective stents 3 separately from the defective ones.

While the invention has been illustrated and described in detail in the drawings and foregoing description, such illustration and description are to be considered illustrative or exemplary and not restrictive and it is not intended to limit the invention to the disclosed embodiments. The mere fact that certain measures are recited in mutually different dependent claims does not indicate that a combination of these measures cannot be used advantageously.

1. A system for detecting defects within a structure of struts forming a stent, comprising:
a power supply for applying an electrical potential to a proximal end and to a distal end of said stent in order to establish an electrical current flow between said proximal end and said distal end, and
a temperature sensor, adjacent to said stent for detecting a defect within said structure of struts, said temperature sensor being adapted to measure a temperature profile of said stent.

2. The system according to claim 1, wherein said temperature sensor is an infrared camera.

3. The system according to claim 1, further comprising a clamping tool for holding the stent.

4. The system according to claim 3, wherein said clamping tool provides at both sides of said clamping tool a connector for said electrical power supply.

5. The system according to claim 3, wherein said clamping tool comprises a drive mechanism for rotating said stent.

6. The system according to claim 3, further comprising a loader for automatically loading said stent into said clamping tool adapted for an automatic operation of said system.

7. The system according to claim 1, wherein said temperature sensor is mounted to a mounting fixture adapted to rotate the temperature senor around the stent.

8. The system according to claim 1, wherein said struts are made of biocompatible materials.

9. The system according to claim 8, wherein said biocompatible material is nitinol.

10. The system according to claim 1, wherein said applied electrical potential is a D.C. voltage.

11. A method of detecting defects within a structure of struts forming a stent, said method comprising:
establishing an electrical current flow between a proximal end and a distal end of said stent by applying an electrical potential to said proximal end and said distal end of said stent;
measuring a temperature of the stent with a temperature sensor, and
detecting said defect within said structure of struts by locating a spot within said structure of struts dissipating a differing temperature compared to an adjacent area within said structure of struts.

12. The method according to claim 11, wherein said temperature sensor is an infrared camera.

13. The method according to claim 11, wherein the temperature sensor and the stent are rotated relative to each other.

14. A system for detecting defects within a structure of struts forming a stent, comprising:
a power supply for applying a D.C. voltage to a proximal end and to a distal end of said stent in order to establish an electrical current flow between said proximal end and said distal end;
a clamping tool to hold the stent, said clamping tool including a drive mechanism for rotating the stent;
a connector connected to said clamping tool and said power supply;
an automatic loader adapted to automatically load the stent into said clamping tool; and
an infrared camera, adjacent to said stent for detecting a defect within said structure of nitinol struts, said temperature sensor being adapted to measure a temperature profile of said stent.

15. The system according to claim 14, wherein said temperature sensor is mounted to a mounting fixture adapted to rotate the temperature senor around the stent.
